(19) United States
(12) Patent Application Publication
(10) Pub. No.: US 2025/0131099 A1
(43) Pub. Date: Apr. 24, 2025

(54) METHOD FOR VERIFYING THE INFORMATION TECHNOLOGY SECURITY OF A COMPUTER SYSTEM

(71) Applicant: Robert Bosch GmbH, Stuttgart (DE)

(72) Inventors: Holger Niemann, Ludwigsburg (DE); Paulius Duplys, Markgroeningen (DE)

(21) Appl. No.: 18/918,602

(22) Filed: Oct. 17, 2024

(30) Foreign Application Priority Data
Oct. 24, 2023 (DE) 10 2023 210 450.4

(51) Int. Cl. G06F 21/57

(52) U.S. Cl. CPC G06F 21/577; G06F 2221/034

(57) ABSTRACT

A method for verifying the information technology security of a computing unit system which includes at least one computing unit. The method includes: providing an information technology model of at least a part of the computing unit system; carrying out at least one information security test attack on the model; receiving data from the model that characterizes a response of the model to the information security test attack; determining at least one parameter in accordance with the received data; evaluating the at least one parameter and assessing the information security-related security of the computing unit system in accordance with the evaluation.

### FIELD

The present invention relates to a method for verifying the information technology security of a computing unit system, and to a computing unit and a computer program for carrying out same.

### BACKGROUND INFORMATION

For companies or organizations that manufacture or distribute products or offer services, for example, it can be of great importance that computing unit systems are well protected against information security attacks or cyber attacks. Such computing unit systems can, for example, represent an IT infrastructure consisting of a plurality of computing units that can be interconnected via at least one network. For example, such computing unit systems can comprise a production network on a production level, in which a plurality of control units or controllers, which can control production machines, for example, can be interconnected via an industrial network. Furthermore, such computing unit systems can, for example, comprise a computer network at an organizational, management or control level of the particular company, wherein, for example, a plurality of computers or PCs are interconnected via a local network and are also connected to the Internet, for example. Furthermore, such computing unit systems can, for example, also comprise or be a network in a product manufactured by the company, e.g. a system of control devices or vehicle computers in a vehicle manufactured by a vehicle manufacturer. The components of such computing unit systems can comprise computers or PCs, control units, networks, gateways, servers, computing systems in the sense of so-called cloud computing, etc.

Information security attacks on such computing unit systems can, for example, lead to production machine failures, which in turn can result in high costs and losses for the company and possibly also for the company's customers. It is therefore desirable to be able to verify and assess the information security of a computing unit system or the resistance of a computing unit system to information security attacks.

### SUMMARY

According to the present invention, a method for verifying the information technology security of a computing unit system, a computing unit and a computer program for carrying out same are provided. Advantageous example embodiments of the present invention are disclosed herein.

In the present context, when the terms “secure” or “security” are mentioned, this is to be understood specifically as information technology security or information security, as opposed to operational safety or functional safety.

According to an example embodiment of the present invention, the computing unit system comprises at least one computing unit, in particular a plurality of computing units, which are interconnected via at least one network. The computing unit system can, for example, represent a company's IT infrastructure and can comprise a plurality of components, e.g. computers or PCs, control units, networks, gateways, servers, computing systems in the sense of so-called cloud computing, etc. Within the framework of the present method, it is verified in particular how secure or how resistant the computing unit system is to information security attacks or cyber attacks.

According to an example embodiment of the present invention, for this purpose, an information technology model of at least a part of the computing unit system is provided. This model can be realized in hardware and/or software. The model can be a real copy or replica of the entire computing unit system or the particular part of the computing unit system, realized in hardware and/or software. Furthermore, the model can also be a purely computer-implemented model, in particular a simulation of components of the entire computing unit system or the particular part of the computing unit system.

At least one (information) security test attack is carried out on the information technology model, for example by actually carrying out an attack on the model or by replicating the effects of an actual attack on the model.

Data are received from the model that characterize a response of the model to the information security test attack. These data describe in particular a response of the model to the test attack carried out. Furthermore, the data describe in particular whether the test attack was successful, how the model is affected by the test attack and how long it takes to recover the initial or normal state before the test attack or to undo the effects of the test attack.

At least one parameter is determined in accordance with the data received. In particular, such a parameter represents a particularly quantitative assessment parameter that can be used to demonstrate how effectively the model can defend against the test attack or, conversely, how successful the test attack on the model was.

The at least one parameter is evaluated and, in accordance with this evaluation, the information security of the computing unit system is assessed. In accordance with the specific value of the determined parameter, it can be expediently inferred and assessed whether the computing system is, for example, well or very well protected against attacks or, for example, vulnerable to certain types of attacks.

The present invention provides a possibility for a dynamic security benchmark of companies, wherein in particular it is possible to assess dynamically or continuously how well the company is protected against cyber attacks or cyber risks. In particular, since the assessment within the framework of the method is carried out based on a model of the actual computing unit system, it is not necessary to carry out test attacks on the real, actual computing unit system, so that there is no risk to the actual computing unit system and the company, no additional security gaps can arise and no unnecessary downtime or standstill time arises for the company. Furthermore, since, by means of the model, the computing unit system or at least the part of the system to be examined can be replicated as precisely as possible, it can be demonstrated in a particularly representative and reliable manner, based on the model, how the actual computing unit system would react to attacks. The model can expediently always be compared with the latest status of the computing unit system, so that the model always replicates the current status of the computing unit system in particular. In this way, a dynamic evaluation can be made possible in a particularly expedient way, wherein the current status of the computing unit system is always verified for its vulnerability to attacks.

By means of a conventional, static evaluation, it can be evaluated which security measures a company employs in order to protect itself against cyber attacks. Such a static view can at least make a rudimentary risk assessment possible. For example, a product that can be updated via so-called “over-the-air updates” (OTA updates) can be more secure than a product that cannot be updated via such updates. Furthermore, an IT network protected by a firewall, for example, can be more secure than a network without a firewall.

In contrast, the present invention makes possible a more reliable, dynamic assessment of cyber risks to which an organization may be exposed, wherein it is not generally assessed which security measures are generally implemented, but wherein it is specifically verified how these security measures specifically react to actual attacks and how well the security measures can defend against attacks.

For example, the actual effectiveness of an OTA update can depend on how well the company's own vulnerability management works and how often and how quickly an update is actually provided. Furthermore, the effectiveness of a firewall can depend, for example, on the quality of the firewall rules and the speed and quality of the response.

According to at least one example embodiment of the present invention, providing the model comprises replicating a hardware of the computing unit system or at least the part of the computing unit system. In particular, the same hardware components or hardware components of the same type or equivalent hardware components as in the real computing unit system can be used in order to create a hardware replica of the computing unit system as the model. Alternatively or additionally, providing the model according to at least one embodiment comprises replicating a current software state of the computing unit system or at least the part of the computing unit system. In particular, the current software version can be used to replicate and test the (software) mechanisms currently implemented in the computing unit system for defending against security attacks. Particularly expediently, a copy or replica of the computing unit system or at least part of the computing unit system in hardware and/or software can be created as the model, wherein in particular the specific hardware and the specific software version of the computing unit system are replicated.

Alternatively or additionally, providing the model according to at least one example embodiment of the present invention comprises creating a virtual machine that simulates or replicates in software the computing unit system or at least the part of the computing unit system. In this case, the model can be created purely by software or computer implementation. The hardware of the real computing unit system can be expediently replicated in the virtual machine and the current software version of the computing unit system can be expediently executed in the virtual machine.

According to at least one example embodiment of the present invention, carrying out the at least one information security test attack comprises carrying out at least one actual information security attack on the model. Such actual attacks can in particular be attacks that have actually been carried out by attackers in the past to attack company systems. The data received by the model can then describe in particular how the model reacts to this attack.

According to at least one example embodiment of the present invention, carrying out the at least one information security test attack comprises implementing at least one attack effect of an actual information security attack in the model. In this case, in particular, no actual attack is carried out on the model, but the effects of known attacks that have actually taken place in the past, for example, are replicated in the model. For example, the data received by the model in this case can describe how the model reacts to these implemented effects and counteracts them.

According to at least one example embodiment of the present invention, carrying out the at least one information security test attack comprises extracting first attack information from a first database, in which information about a plurality of actual information security attacks is stored. The at least one actual information security attack on the model is carried out in accordance with this extracted first attack information. For example, scripts or source codes of the actual attacks can be stored in this first database, which can be read in and executed in order to carry out the particular attack on the model.

According to at least one example embodiment of the present invention, carrying out the at least one information security test attack comprises extracting second attack effect information from a second database, in which information about a plurality of attack effects is stored. The at least one attack effect is implemented in the model in accordance with this extracted second attack effect information. For example, known effects of known attacks can be stored in the second database, so that a specific attack can be simulated by implementing a corresponding effect of this attack in the model.

According to at least one example embodiment of the present invention, an attack success rate is determined as a parameter that describes a ratio of a number of successful test attacks to a total number of test attacks or a number of test attacks carried out as a whole. Successful test attacks are to be understood in particular as test attacks carried out that can fulfill the purpose of the attack and that can overcome the security mechanisms of the model or the computing unit system. Alternatively or additionally, a resistance value can be determined as a parameter that describes a ratio of a number of unsuccessful test attacks to a total number of test attacks carried out. Unsuccessful test attacks are to be understood in particular as test attacks that cannot fulfill the purpose of the attack and that are successfully defended against by the security mechanisms of the model or the computing unit system. This attack success rate, or resistance value, in each case represents a quantitative assessment parameter indicating how successfully the model and thus the computing system can defend against and resist security attacks.

According to at least one example embodiment of the present invention, a recovery time is determined as a parameter that describes a time interval between a first point in time at which the carrying out of a particular test attack is started and a second point in time at which a state of the model is recovered which corresponds to an initial state prior to the carrying out of the particular test attack. In particular, this recovery time represents a quantitative assessment parameter for how quickly the model and thus the computing unit system can recover after a successful attack and how quickly the original initial state can be recovered after a successful attack. The longer the recovery time, the greater the overall loss can be for the particular company, which can comprise both internal costs, e.g. in order to bring the company back online, and losses due to contractual obligations. For example, if the company is unable to deliver products to a customer for a certain period of time due to a high recovery time, that customer may have to stop production and pay suppliers.

According to at least one example embodiment of the present invention, a specified action is carried out on the real, actual computing unit system in accordance with the evaluation. Expediently, with the aid of this action the information technology security of the computing unit system can be increased. For example, with the aid of the action, a vulnerability of the computing unit system to special security attacks recognized in the course of the evaluation can be counteracted. In particular, a modification to the hardware and/or software of the computing unit system can be carried out as such an action.

According to at least one example embodiment of the present invention, the specified action is a (software) update of one or more components of the computing unit system. For example, by means of such an update, the software version of the particular component can be updated in order to reduce the vulnerability of this component to specific attacks.

Alternatively or additionally, according to at least one example embodiment of the present invention, a configuration and/or a setting of one or more components of the computing unit system is modified as a specified action. For example, security gaps in the particular hardware and/or software components can be closed in this way.

Alternatively or additionally, as a specified action according to at least one example embodiment of the present invention, one or more components of the computing unit system are replaced and/or one or more new components are added to the computing unit system. For example, security-vulnerable components can be replaced with new, less vulnerable versions. Furthermore, new hardware and/or software components can be installed in the computing unit system, for example, which offer improved protection against attacks.

According to at least one example embodiment of the present invention, evaluating the at least one parameter comprises a comparison of the at least one parameter with at least one threshold value. For example, by means of these threshold values, categories for how well or how poorly the computing unit system is secured against attacks can be defined. Expediently, one or more of the specified actions can be carried out if the at least one parameter reaches, exceeds or falls below a particular threshold value.

A computing unit according to an example embodiment of the present invention is configured, in particular with respect to programming, to carry out a method according to the present invention.

Furthermore, the implementation of a method according to the present invention in the form of a computer program or computer program product having program code for carrying out all the method steps is advantageous because it is particularly low-cost, in particular if an executing control unit is also used for further tasks and is therefore present anyway. Finally, a machine-readable storage medium is provided with a computer program as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.). Such a download can be wired or wireless (e.g., via a WLAN network or a 3G, 4G, 5G or 6G connection, etc.).

Further advantages and embodiments of the present invention can be found in the description and the figures.

The present invention is illustrated schematically in the figure on the basis of an example embodiment and is described below with reference to the figure.

### BRIEF DESCRIPTION OF THE DRAWING

FIG. 1 schematically shows a system for verifying the information technology security of a computing unit system, which is configured to carry out an embodiment of a method according to an example embodiment of the present invention.

### DETAILED DESCRIPTION OF EXAMPLE EMBODIMENTS

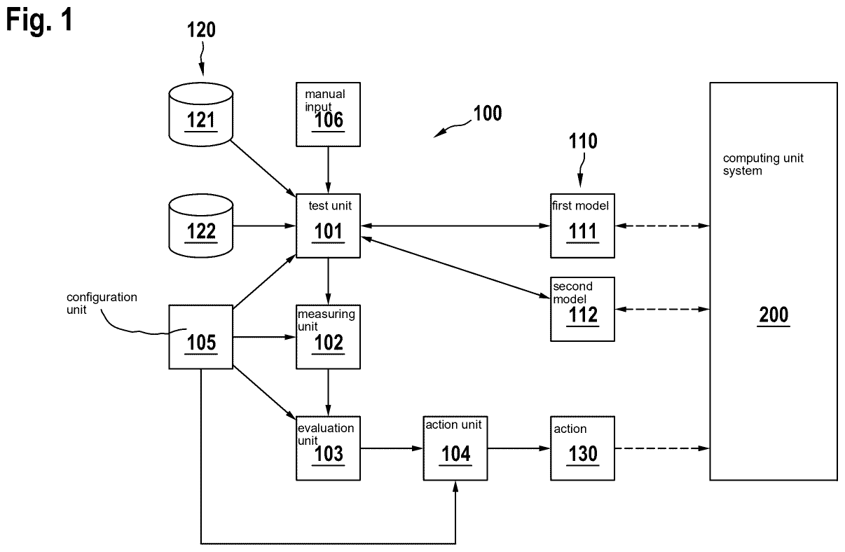

FIG. 1 schematically shows a system 100 for verifying the information technology security of a computing unit system 200, hereinafter also referred to as the verification system 100.

The computing unit system 200 to be verified can, for example, be operated by a company and can, for example, comprise a production network on a production level in which, e.g., control units for controlling production machines are connected via an industrial network. Furthermore, the computing unit system 200 can, for example, comprise a computer network in an organizational, management or control level, wherein computers are interconnected via a local network, along with, for example, servers and a computing system in the sense of cloud computing. The computing unit system 200 can, for example, also comprise or be a network in a product manufactured by the company, e.g., a system of control devices or vehicle computers in a vehicle.

The computing unit system 200 is shown in FIG. 1 in a highly simplified form as a single element, but it is understood that the computing unit system 200 can comprise a plurality of components, e.g. computers, control units, networks, gateways, servers, computing systems in the sense of so-called cloud computing, etc.

The verification system 100 is provided to continuously and dynamically assess how well the computing unit system 200 is protected against information security attacks or cyber attacks. For this purpose, the verification system 100 is configured to carry out an embodiment of a method according to the present invention.

Within the framework of this example embodiment, at least one information technology model 110 of at least a part of the computing unit system 200 is provided. In particular, two information technology models 111, 112 are provided. For example, a first model 111 can be provided which is a copy or replica of the computing unit system 200 in hardware and software, wherein, for example, the same or equivalent hardware components as in the real computing unit system 200 are used and wherein the current software version of the computing unit system 200 is executed on these hardware components. Furthermore, a second model 112 can be provided in the form of a virtual machine that simulates or replicates in software the computing unit system 200.

The first model 111 and the second model 112 can in each case always be compared with the latest status of the computing unit system, indicated by the two dashed double arrows, so that the models 111 and 112 in each case always replicate the current status of the computing unit system.

The verification system 100 comprises a test unit 101 that carries out information security test attacks on the models 111, 112. As such test attacks, the test unit 101 can carry out actual information security attacks on the models or also implement attack effects of actual information security attacks in the models. For this purpose, databases 120 can be provided in which information about information security attacks is stored. For example, the test unit 101 can extract attack information from a first database 121, in which scripts of information security attacks are stored. The test unit 101 can execute the particular extracted scripts, in order to carry out a particular attack on the models 110. Furthermore, the test unit 101 can extract attack effect information from a second database 122, in which attack effect information is stored. In accordance with this extracted attack effect information, the test unit can implement corresponding effects of an attack in the models 110.

For example, with the aid of specified configuration data, a configuration unit 105 configure the test unit 101 to determine which specific test attacks the test unit 101 should carry out. Furthermore, it can also be specified by a manual input 106, for example by a user of the system 100, which test attacks the test unit 101 should carry out.

The verification system 100 further comprises a measuring unit 102, wherein this measuring unit receives data from the models 110 that characterize a response of the models 110 to the test attack carried out. This received data can, for example, characterize a particular status of individual components of the models 110 or individually simulated components of the computing unit system 200. For example, the data can also comprise metadata, e.g. time stamps.

Furthermore, the measuring unit 102 determines at least one parameter in accordance with the data received. For example, the measuring unit 102 can determine a resistance value as a parameter, which describes a ratio of a number of unsuccessful or repelled test attacks to a total number of test attacks carried out as a whole. Furthermore, the measuring unit 102 can determine a recovery time as a parameter, which describes a time interval between a first point in time at which the carrying out of a particular test attack is started and a second point in time at which a state of the model is recovered which corresponds to an initial state prior to the carrying out of the particular test attack.

For example, it can be specified by the configuration unit 105 or corresponding configuration data which data the measuring unit 102 should receive and how the measuring unit 102 should determine the parameters from this received data.

The determination of the resistance value can comprise context-dependent calculations and an assessment based on one or more attack profiles. For example, damage caused by the attack can be taken into account, e.g. whether a service was temporarily interrupted or whether all data on a server were destroyed by malware. Furthermore, the assumed capabilities of an attacker can be taken into account, e.g. whether the attack only works with public information or whether internal information is required. The recovery time can, for example, be a function of the status of individual components. If, for example, 50% of the IT infrastructure capacity is sufficient in order to keep business-critical processes running, the recovery time can be defined as the time that is required to recover at least half of the infrastructure capacity.

The verification system 100 further comprises an evaluation unit 103, wherein this evaluation unit 103 evaluates the determined parameters and, in accordance with this evaluation, assesses the information security of the computing unit system 200. For this purpose, the evaluation unit 103 can compare the determined parameters in each case with threshold values. For example, it can be defined with these threshold values how well or how poorly the computing unit system is secured against attacks. For example, these threshold values can be specified by the configuration unit 105 or by the configuration data.

In accordance with the evaluation by the evaluation unit 103, in particular in accordance with the threshold value comparison, a response or action unit 104 determines a specified action to be carried out on the computing unit system 200. In the course of this action, in particular a modification is to be carried out on the computing unit system 200, or the computing unit system 200 is to be influenced in order to increase the information security of the computing unit system 200. Depending on whether the individual parameters in each case reach a threshold value or depending on which specific threshold value the individual parameters reach, the action unit 104 can determine an individual action to be carried out. These actions can comprise, for example, an update of one or more components of the computing unit system 200 along with the modification of a configuration or setting of individual components of the computing unit system 200, the replacement of individual components of the computing unit system 200 and the addition of a new component to the computing unit system 200. For example, the individual actions associated with the particular threshold values can be specified by the configuration unit 105 or by the configuration data. The action 130 determined by the action unit 104 is then carried out on the computing unit system 200, indicated by the dashed arrow in FIG. 1.

The verification system 100 can, for example, be designed as a computing unit or also as a network of different computing units, wherein the individual units 101, 102, 103, 104, 105 of the verification system 100 in each case can be designed as individual hardware and/or software components of this computing unit or this network of computing units.

The present invention thus makes possible a dynamic security benchmark of companies, in order to be able to dynamically or continuously assess how effectively the company can counter and resist cyber attacks. The verification system 100 based on the models 110 makes possible a dynamic simulation of the security situation of the organization, without endangering the actual computing unit system 200 and thus without endangering the actual organization and its infrastructure. In particular, the model 110 or the simulated environment is not decoupled from the actual organization, but is coupled in particular with the real organization or the real computing unit system 200, in order to always be able to map the current status of the computing unit system 200 and thus to be able to determine how well the company reacts to different types of attacks. Furthermore, the proposed system 100 makes it possible for the company to simulate a plurality of potential solutions before they are actually implemented.

1-11. (canceled)

12. A method for verifying information technology security of a computing unit system which includes at least one computing unit, the method comprising the following steps:
providing an information technology model of at least a part of the computing unit system;
carrying out at least one information security test attack on the model;
receiving data from the model that characterize a response of the model to the information security test attack;
determining at least one parameter in accordance with the received data;
evaluating the at least one parameter and assessing the information security-related security of the computing unit system in accordance with the evaluation.

13. The method according to claim 12, wherein the providing of the information technology model includes:
replicating a hardware of the computing unit system or at least the part of the computing unit system; and/or
replicating a current software status of the computing unit system or at least the part of the computing unit system; and/or
creating a virtual machine that simulates the computing unit system or at least the part of the computing unit system.

14. The method according to claim 12, wherein the carrying out of the at least one information security test attack includes:
carrying out at least one actual information security attack on the model; and/or
implementing at least one attack effect of an actual information security attack in the model.

15. The method according to claim 14, wherein the carrying out of the at least one information security test attack includes:
(i) extracting first attack information from a first database, in which information about a plurality of actual information security attacks is stored, and carrying out the at least one actual information security attack on the model in accordance with the extracted first attack information; and/or
(ii) extracting second attack effect information from a second database, in which information about a plurality of attack effects is stored, and implementing the at least one attack effect in the model in accordance with the extracted second attack effect information.

16. The method according to claim 12, wherein the at least one parameter includes one or more of the following parameters:
an attack success rate, which describes a ratio of a number of successful test attacks to a total number of test attacks;
a resistance value, which describes a ratio of a number of unsuccessful test attacks to a total number of test attacks;
a recovery time, which describes a time interval between a first point in time at which the carrying out of a particular test attack is started and a second point in time at which a state of the model is recovered which corresponds to an initial state prior to the carrying out of the particular test attack.

17. The method according to claim 12, further comprising:
carrying out a specified action on the computing unit system in accordance with the evaluation.

18. The method according to claim 17, wherein the carrying out of the specified action includes:
carrying out an update of one or more components of the computing unit system; and/or
modifying a configuration and/or settings of one or more components of the computing unit system; and/or
replacing one or more components of the computing unit system; and/or
adding one or more new components to the computing unit system.

19. The method according to claim 12, wherein the evaluating of the at least one parameter includes a comparison of the at least one parameter with at least one threshold value.

20. A computing unit configured to verify information technology security of a computing unit system which includes at least one computing unit, the computing unit being configured to:
provide an information technology model of at least a part of the computing unit system;
carry out at least one information security test attack on the model;
receive data from the model that characterize a response of the model to the information security test attack;
determine at least one parameter in accordance with the received data;
evaluate the at least one parameter and assessing the information security-related security of the computing unit system in accordance with the evaluation.

21. A non-transitory machine-readable storage medium on which is stored a computer program for verifying the information technology security of a computing unit system which includes at least one computing unit, the computer program, when executed by a computer, causing the computer to perform the following steps:
providing an information technology model of at least a part of the computing unit system;
carrying out at least one information security test attack on the model;
receiving data from the model that characterize a response of the model to the information security test attack;
determining at least one parameter in accordance with the received data;
evaluating the at least one parameter and assessing the information security-related security of the computing unit system in accordance with the evaluation.
